(19) United States
(12) Patent Application Publication
(10) Pub. No.: US 2015/0040287 A1
(43) Pub. Date: Feb. 12, 2015

(54) Hand Disguise for Hunters

(71) Applicant: Duane Miller, Onawa, IA (US)

(72) Inventor: Duane Miller, Onawa, IA (US)

(21) Appl. No.: 14/457,772

(22) Filed: Aug. 12, 2014

Related U.S. Application Data
(60) Provisional application No. 61/864,678, filed on Aug. 12, 2013.

(51) Int. Cl. A01M 31/00; F41B 5/14; A41D 19/00

(52) U.S. Cl. CPC A01M 31/00; A41D 19/0024; F41B 5/148
USPC 2/160

(57) ABSTRACT

The disclosed apparatus, systems and methods relate to a hand disguise for hunters. The hand disguise has a glove and a sleeve which is adapted to fit one or more fingers. The sleeve is also connected to a tail region, which is adapted to resemble the tail of a small animal. In certain applications, the disguise can be used by a hunter as a means of mimicking the behavior of a small animal. Various disguises include real or artificial fur or feathers.

### CROSS-REFERENCE TO RELATED APPLICATION(S)

This application claims priority from U.S. Provisional Application 61/864,678, filed Aug. 12, 2013, and entitled “Hand Disguise for Hunters,” which is hereby incorporated herein by reference in its entirety.

### TECHNICAL FIELD

The disclosure relates generally to sporting equipment. More specifically it relates to a hand disguise that facilitates the hunting of wild game, such as deer. The invention thus relates to devices, systems and methods adapted for use with the hunting of animals by way of bow and arrow or firearm.

### BACKGROUND

One of the most popular outdoor sports is hunting. Many hunters have discovered the great challenge and excitement of hunting with a close-range weapon, such as a bow and arrow. But frequently, the act of notching, drawing and releasing an arrow or other projectile weapon can startle or otherwise “spook” the game animal. There is a need in the art for improved hunting methods, systems and apparatus.

### BRIEF SUMMARY

Discussed herein are various embodiments relating to a hand disguise, or hunting glove for use with projectile weapons. Additional features and advantages of the invention will be set forth in the description which follows, and will be apparent from the description, or may be learned by practice of the invention. The foregoing general description and the following detailed description are exemplary and explanatory and are intended to provide further explanation of the invention.

In Example 1, a hand disguise comprises a glove having first and second ends and front and back sides, the glove further comprising a sleeve disposed at or near the first end and configured to accept one or more fingers; and a tail disposed at or near the front side of the glove and in operational communication with the sleeve so as to be capable of moving in response to the movement of one or more fingers.

Example 2 relates to the hand disguise according to Example 1, further comprising a wristband.

Example 3 relates to the hand disguise of Example 2, further comprising a material selected from the group consisting of: real fur, facsimile animal fur and feathers.

Example 4 is the hand disguise of Example 3, further comprising an open palm region.

Example 5 is the hand disguise of Example 3, further comprising a body disposed at or near the second, front end of the glove.

Example 6 is the hand disguise of Example 5, wherein the body is comprised of a material selected from the group consisting of: real fur, facsimile animal fur and feathers.

Example 7 is a method for disguising a user's hand, comprising: providing a hand disguise further comprising a glove having first and second ends and front and back sides, the glove further comprising: a sleeve disposed at or near the first end and configured to accept one or more fingers; and a tail disposed at or near the front side of the glove and in operational communication with the sleeve so as to be capable of moving in response to the movement of one or more fingers; and providing a projectile hunting weapon; and disguising the hand of the user with the hand disguise while the user is operating the projectile weapon.

Example 8 is the method of Example 7, further comprising providing a wristband.

Example 9 is the hand disguise of Example 8, wherein the tail material is selected from the group consisting of: real fur, facsimile animal fur and feathers.

Example 10 is the hand disguise of Example 8, wherein the glove further comprises an open palm region.

Example 11 is the hand disguise of Example 10, wherein the glove further comprises a body disposed at or near the second, front end of the glove.

Example 12 is a system for concealing a hunter's hand comprising: a glove having first and second ends and front and back sides, the glove further comprising: a sleeve disposed at or near the first end and configured to accept one or more fingers; a tail disposed at or near the front side of the glove and in operational communication with the sleeve so as to be capable of moving in response to the movement of one or more fingers; and disguising the hand of the hunter with the glove while the hunter is operating a projectile weapon.

Example 13 is the system of Example 12, further comprising a wristband.

Example 14 is the hand disguise of Example 13, wherein the glove further comprises a body fixedly attached to the second, front end of the glove.

Example 15 is the system of Example 14, further comprising a material selected from the group consisting of: real fur, facsimile animal fur and feathers.

Example 16 is the system of Example 15, wherein the glove further comprises an open palm region.

While multiple embodiments are disclosed, still other embodiments of the disclosure will become apparent to those skilled in the art from the following detailed description, which shows and describes illustrative embodiments of the disclosed apparatus, systems and methods. As will be realized, the disclosed apparatus, systems and methods are capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a front view of an exemplary embodiment of the hand disguise, showing the user's hand, the body and the tail.

FIG. 2 is a rear view of the embodiment of FIG. 1.

FIG. 3A is a perspective view of an exemplary embodiment of the hand disguise in use in the hunting of deer, from the perspective of a user.

FIG. 3B. is a depiction of another embodiment of the hand disguise, in use on a bow, from the perspective of a game animal.

FIG. 4 is a rear view of another exemplary embodiment of the hand disguise, showing the user's hand placing two fingers in the sleeve.

FIG. 5 is a perspective front view of the embodiment of FIG. 4, showing the user's hand placing two fingers in the sleeve.

FIG. 6 is yet another perspective rear view of the embodiment of FIG. 4.

FIG. 7 is a perspective rear view of the embodiment of FIG. 4, without a user's hand.

### DETAILED DESCRIPTION

The invention relates generally to hunting accessories and in particular to a hand disguise for hunters. When hunting, the game animal, such as a deer or antelope, must be approached by the hunter to within 25 to 50 yards, without frightening or alerting the animal; from longer ranges, scoring a hit is extremely difficult even for the most accurate shooters. Most of the human body is easily concealed with camouflage clothing, due to the slower movements by those portions of the body. In contrast, experienced hunters have found that hand movement, as the hunter positions and aims his weapon, is the most difficult to control and therefore most likely to frighten animals. Unfortunately, such hand movements are usually unavoidable in archery and other pursuits involving projectile weapons. A hand disguise, to make the animal think the human hand is actually a small, harmless animal such as a squirrel, badger or bird, would be an effective device in these situations.

Wherever the phrase “for example,” “such as,” “including” and the like are used herein, the phrase “and without limitation” is understood to follow unless explicitly stated otherwise. Similarly “an example,” “exemplary” and the like are understood to be non-limiting.

The terms “comprising” and “including” and “having” and “involving” (and similarly “comprises”, “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etc. Thus, for example, “a process involving steps a, b, and c” means that the process includes at least steps a, b and c.

Wherever the terms “a” or “an” are used, “one or more” is understood, unless such interpretation is nonsensical in context.

Exemplary embodiments of the invention may relate specifically to various apparatus, systems or methods. For brevity in this description, these embodiments may be variously referred to as the “hand disguise” or “glove,” neither of which is intended to limit the scope of the invention to a single modality. Accordingly, the invention is directed to a hand disguise for hunters, which encompasses an apparatus, system and associated method of use in the hunting of game animals.

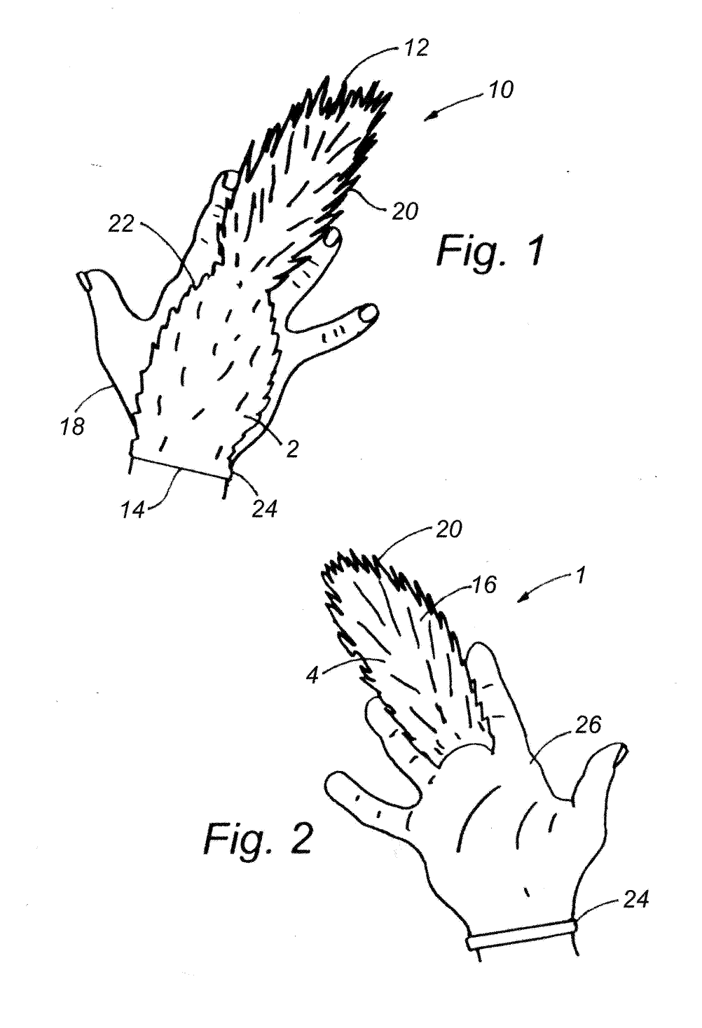

Referring now to the invention in more detail, and FIGS. 1-2 in particular, exemplary embodiments are directed to a hand disguise 1 which comprises a glove 10 for hunters. In exemplary embodiments, the disguise 1 comprises a glove 10 which generally comprises first 12 and second 14 ends, and front 2 and back 4 sides, depicted in FIGS. 1-2, respectively. In exemplary embodiments, the first end 12 further comprises a sleeve 16, which is adapted or otherwise configured to accept one or more fingers, as is apparent from the figures. In certain embodiments, the hand disguise may have an open palm 26 region. In exemplary embodiments, the hand disguise 1 further comprises a wristband 24.

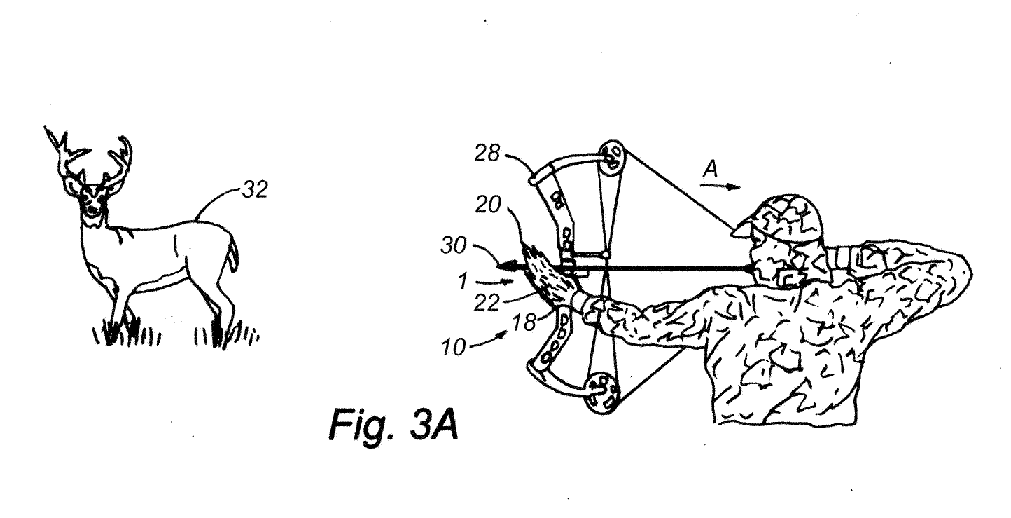

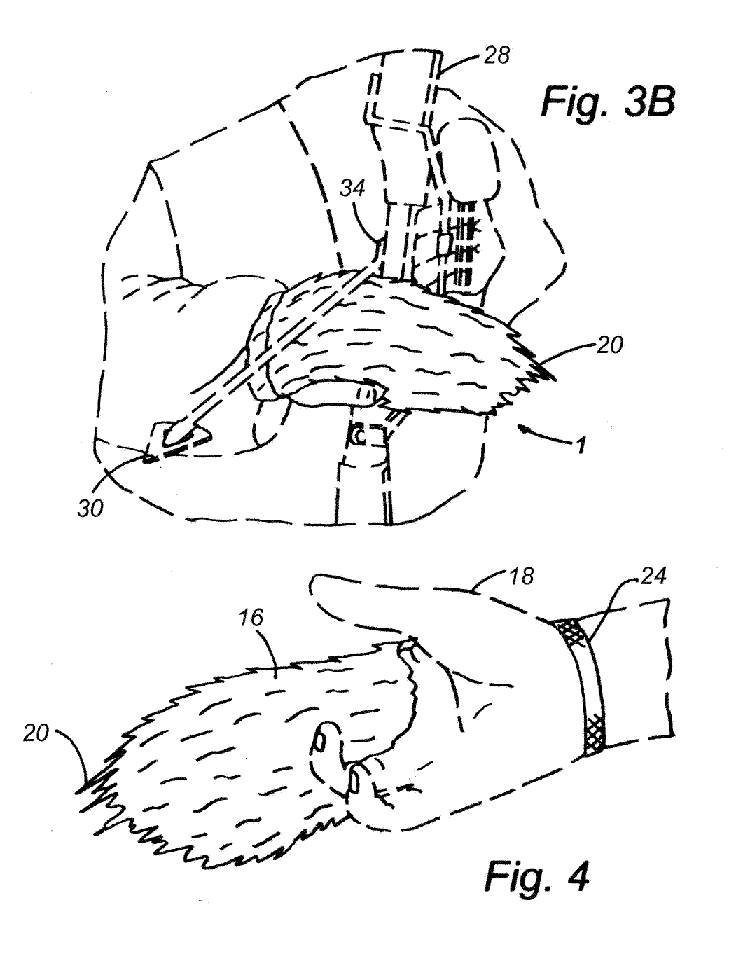

A principle aim of the various embodiments of the glove 10 is to induce a game animal to respond to the moving human hand 18 (which is typically placed on the bow, or other weapon, as is shown in reference to FIGS. 3A-3B) as that animal would a small, harmless animal such as a squirrel, badger or bird. Accordingly, in certain embodiments, such as the embodiment of FIGS. 1-2, the first end 12 and sleeve 16 further comprise a tail region 20, which is fixedly attached to the front portion of the glove 10 near the first end 12. In certain embodiments, the hand disguise 1 or glove 10 further comprises a body region 22 which is fixedly attached or fully integrated with the second end 14. In these embodiments, both the tail 20 and body 22 are adapted to mimic the appearance of a small animal, as discussed further herein.

The tail region 20 is accordingly adapted to mimic such an animal and is used to disguise the hunter's hand 18. In certain exemplary embodiments, the hand disguise 1 comprises a tail region 20 and body region 22 which further comprise real or facsimile animal fur, feathers or the like, or are otherwise configured to appear as an animal. By way of example, in the embodiment of FIGS. 1 and 2, the glove tail and body are configured to resemble a squirrel. Real fur, feathers, and the like may be used, as well as synthetic (or “faux”) fur, such as synthetic fibers, crylic and modacrylic polymers, and the like. Other embodiments, designed to resemble other small, non-predatory mammals and birds from various habitats, are also contemplated. In these embodiments, the glove 10 is thus adapted to appear to a game animal to be a harmless and non-threatening element of the environment such that game animals are less likely to be frightened away as the hunter positions and aims his weapon.

In certain exemplary embodiments, and as shown variously in the figures, the sleeve 16 is adapted to accommodate one or more fingers so as to be capable of moving the tail 20 in a manner similar to that of a small animal, rather than appearing to the game animal as the movement of a human or larger animal. Further, this appearance and movement has been found to induce a startle or freeze reflex in the prey, which in certain circumstances can make the animal pause briefly, which enhances the hunter's ability to make their shot.

Certain exemplary embodiments also feature a wrist band 24 and may comprise further loops concealed inside the base of the tail for the user's second finger to be inserted (as is shown in FIGS. 4-7). These embodiments enable the user to mimic the lifelike movement of a squirrel's tail by twitching or otherwise moving one or more fingers.

As depicted in FIG. 3A-B, in certain exemplary embodiments, the glove 10 serves as a system or method to disguise the hunter's lead, or bow, hand 18 at or near the grip, or arrow rest/shelf region 34 of the bow 28 during the draw and release process. Certain embodiments can be used with traditional and compound bows 28.

In these embodiments, the disguise 10 operates to conceal the hunter's hand 18 during the draw and release phase of the bow hunting process, and any movements of the hand 18 near the arrow 30 during this process are translated into movement of the tail 20 and body 22 regions, so as to mimic the movement of a small animal, and therefore not frighten the game animal 32. This movement is depicted with reference arrow A. In certain embodiments, this movement can resemble a twitch, shudder or a quiver. Further, in certain embodiments, the movement of the tail region 20 or body region 22 can induce the freezing of the game animal 32, as is shown in FIG. 3A.

As is also shown in FIGS. 3A-3B, to use the glove 10, the user slips the hand 18 through the wristband 24, and the finger of the hand into the finger loop inside the sleeve 16 and tail 20. As the hunter and the game animal 32 draw closer, the user can then twitch, or otherwise move at least one finger to mimic the lifelike movement of the glove 10. In so doing, the user's hand movements are disguised from the game animal, and in certain embodiments the animal 32 freezes as an instinctual response, thereby making the hunting of the game easier and more convenient. Thus, in certain circumstances the movement of the tail 20 can be an involuntary byproduct of the notch, draw and release process, while in further embodiments the movement A is purposeful and directed toward attracting or freezing the game animal 32.

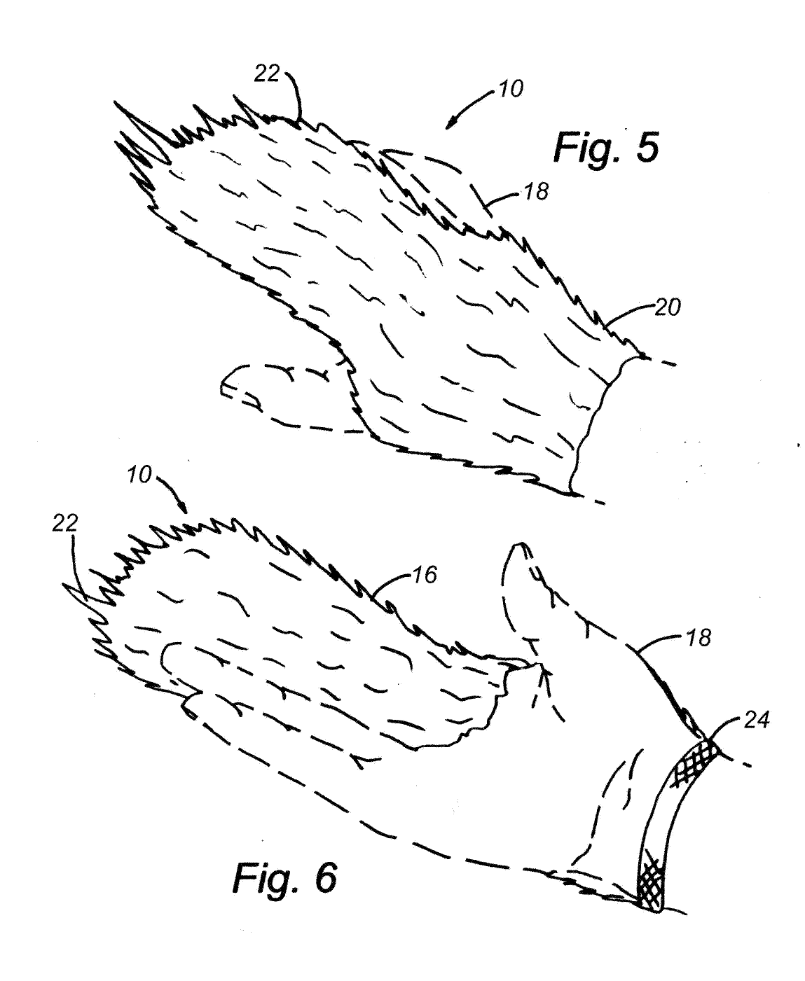

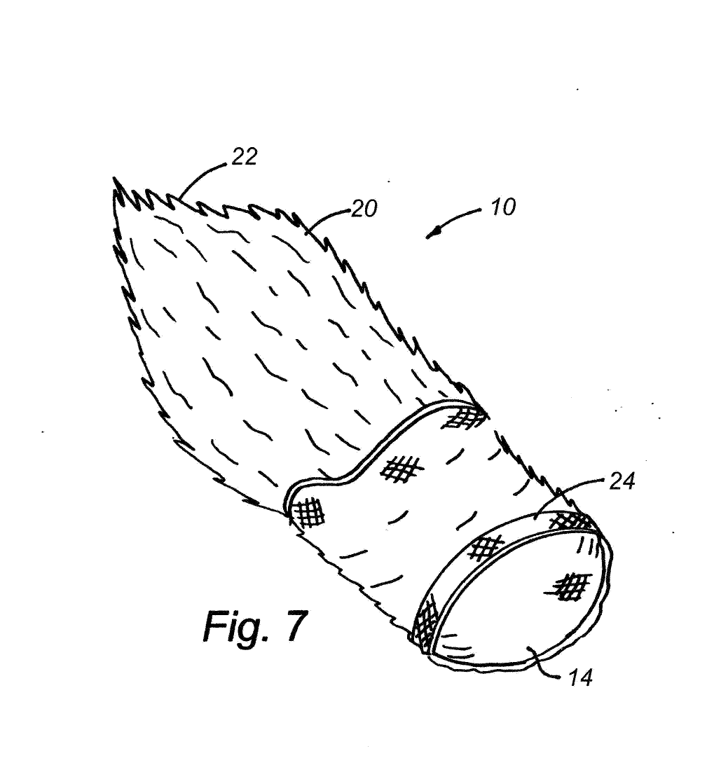

As depicted in FIG. 4, in certain embodiments, the sleeve 16 may be adapted to accommodate more than one finger. In these embodiments, the sleeve 16 and therefore the tail 20 are operated by way of the one or more fingers. These embodiments are depicted further in FIGS. 5-7. As is depicted in FIG. 5, in certain embodiments, the tail 20 and body 22 may be seamlessly linked, such as by way of the fur covering. FIGS. 6-7 depict further embodiments of the glove 10, showing the two finger sleeve 16 and wristband 24.

The body and tail are preferably manufactured from lifelike, flexible, durable materials such as imitation fur, faux fur or real animal fur. The wristband and finger loops are preferably manufactured from an elastic, flexible, durable material such as elasticized cotton.

Components, component sizes, and materials listed above are preferable, but artisans will recognize that alternate components and materials could be selected without altering the scope of the invention.

Although the disclosure has been described with reference to preferred embodiments, persons skilled in the art will recognize that changes may be made in form and detail without departing from the spirit and scope of the disclosed apparatus, systems and methods.

What is claimed is:

1. A hand disguise comprising a glove having first and second ends and front and back sides, the glove further comprising:
a. a sleeve disposed at or near the first end and configured to accept one or more fingers; and
b. a tail disposed at or near the front side of the glove and in operational communication with the sleeve so as to be capable of moving in response to the movement of one or more fingers.

2. The hand disguise of claim 1, further comprising a wristband.

3. The hand disguise of claim 2, further comprising a material selected from the group consisting of: real fur, facsimile animal fur and feathers.

4. The hand disguise of claim 3, further comprising an open palm region.

5. The hand disguise of claim 3, further comprising a body disposed at or near the second, front end of the glove.

6. The hand disguise of claim 5, wherein the body is comprised of a material selected from the group consisting of: real fur, facsimile animal fur and feathers.

7. A method for disguising a user's hand, comprising:
a. providing a hand disguise further comprising a glove having first and second ends and front and back sides, the glove further comprising:
i. a sleeve disposed at or near the first end and configured to accept one or more fingers; and
ii. a tail disposed at or near the front side of the glove and in operational communication with the sleeve so as to be capable of moving in response to the movement of one or more fingers; and
b. providing a projectile hunting weapon; and
c. disguising the hand of the user with the hand disguise while the user is operating the projectile weapon.

8. The method of claim 7, further comprising providing a wristband.

9. The hand disguise of claim 8, wherein the tail material is selected from the group consisting of: real fur, facsimile animal fur and feathers.

10. The hand disguise of claim 8, wherein the glove further comprises an open palm region.

11. The hand disguise of claim 10, wherein the glove further comprises a body disposed at or near the second, front end of the glove.

12. A system for concealing a hunter's hand comprising:
a. a glove having first and second ends and front and back sides, the glove further comprising:
i. a sleeve disposed at or near the first end and configured to accept one or more fingers;
ii. a tail disposed at or near the front side of the glove and in operational communication with the sleeve so as to be capable of moving in response to the movement of one or more fingers; and
b. disguising the hand of the hunter with the glove while the hunter is operating a projectile weapon.

13. The system of claim 12, further comprising a wristband.

14. The hand disguise of claim 13, wherein the glove further comprises a body fixedly attached to the second, front end of the glove.

15. The system of claim 14, further comprising a material selected from the group consisting of: real fur, facsimile animal fur and feathers.

16. The system of claim 15, wherein the glove further comprises an open palm region.
